(19) United States
(12) Patent Application Publication
(10) Pub. No.: US 2008/0098166 A1
(43) Pub. Date: Apr. 24, 2008

(54) Data storage device and data controlling method

(75) Inventors: Kenichi Nakanishi, Tokyo (JP); Daisuke Nakajima, Tokyo (JP); Hideaki Okubo, Saitama (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 11/974,771

(22) Filed: Oct. 16, 2007

(30) Foreign Application Priority Data
Oct. 19, 2006 (JP) P2006-285297

(51) Int. Cl. G06F 12/00

(52) U.S. Cl. 711/103; 711/E12.001

(57) ABSTRACT

A data storage device detachably connected to a host device, the data storage device including: a memory having a logical space composed of at least one logical unit; a logical space managing table for managing the logical space; and a controlling section configured to control a managing operation of the logical space managing table, and when the host device makes a request to divide the logical space, searching the logical space for unused logical blocks, dividing a logical space composed of the unused logical blocks from the logical space, and performing control to manage a plurality of the obtained logical spaces as different logical units, respectively.

### CROSS REFERENCES TO RELATED APPLICATIONS

The present invention contains subject matter related to Japanese Patent Application JP 2006-285297 filed in the Japan Patent Office on Oct. 19, 2006, the entire contents of which being incorporated herein by reference.

### BACKGROUND OF THE INVENTION

1. Field of the Invention

The present invention relates to a data storage device and a data controlling method that can divide a logical space within a memory.

2. Description of the Related Art

There is an existing technology for dividing a logical space into a predetermined number of areas in a storage device or the like to use the memory areas for different purposes.

For example, the following Patent Document 1 (Japanese Patent No. 3699890) describes a nonvolatile semiconductor storage device that can simultaneously perform erasure, writing, and reading in partition units. This Patent Document 1 includes a description to the effect that a partition used in the nonvolatile semiconductor storage device includes a plurality of memory blocks, and that the number of memory blocks included in one partition can be changed by external command control.

### SUMMARY OF THE INVENTION

However, in general, when a memory is divided by partitions, partitions can be set only in a memory initialized to become a completely free space, and partition configuration cannot be changed in a state in which data is written in the memory.

The present invention is proposed in view of such an actual situation, and it is desirable to provide a data storage device and a data controlling method that can divide a logical space into a plurality of logical spaces according to a request of a user even in a memory area in which data is written.

According to an embodiment of the present invention, there is provided a data storage device detachably connected to a host device, the data storage device including: a memory having a logical space composed of at least one logical unit; a logical space managing table for managing the logical space; and controlling means for controlling a managing operation of the logical space managing table, and when the host device makes a request to divide the logical space, searching the logical space for unused logical blocks, dividing a logical space composed of the unused logical blocks from the logical space, and performing control to manage a plurality of the obtained logical spaces as different logical units, respectively.

According to an embodiment of the present invention, there is provided a data controlling method for use by a data storage device, the data storage device including a memory having a logical space composed of at least one logical unit and being detachably connected to a host device, the data controlling method including: controlling a managing operation of a logical space managing table for managing the logical space, and when the host device makes a request to divide the logical space, searching the logical space for unused logical blocks, dividing a logical space composed of the unused logical blocks from the logical space, and performing control to manage a plurality of the obtained logical spaces as different logical units, respectively.

According to the present invention, even a logical unit in which data is written is searched for a free space corresponding to a memory space requested by a command. It is thereby possible to make effective use of a memory area according to purposes of the user.

### BRIEF DESCRIPTION OF THE DRAWINGS

FIG. 1 is a diagram showing a configuration of a data communication system according to an embodiment to which the present invention is applied;

FIG. 2 is a diagram showing an example of commands issued by an application executed by a host device;

FIG. 3 is a diagram showing an example of commands issued by an application executed by the host device;

FIG. 4 is a diagram showing a physical space and a logical space possessed by a flash memory;

FIG. 5 is a diagram showing an example of security functions set to logical units;

FIG. 6 is a flowchart of assistance in explaining an example of a process of dividing a logical space;

FIG. 7 is a diagram showing an initial state of the memory;

FIGS. 8A and 8B are diagrams representing an example of the logical space dividing process;

FIGS. 9A and 9B are diagrams representing an example of the logical space dividing process;

FIG. 10 is a flowchart of assistance in explaining an example of a process of uniting logical spaces;

FIGS. 11A and 11B are diagrams representing an example of the logical space uniting process; and

FIGS. 12A and 12B are diagrams representing an example of the logical space uniting process.

### DETAILED DESCRIPTION OF THE PREFERRED EMBODIMENTS

A concrete embodiment to which the present invention is applied will hereinafter be described in detail with reference to the drawings. In the present embodiment, a nonvolatile semiconductor storage device is applied as a data storage device according to the embodiment of the present invention.

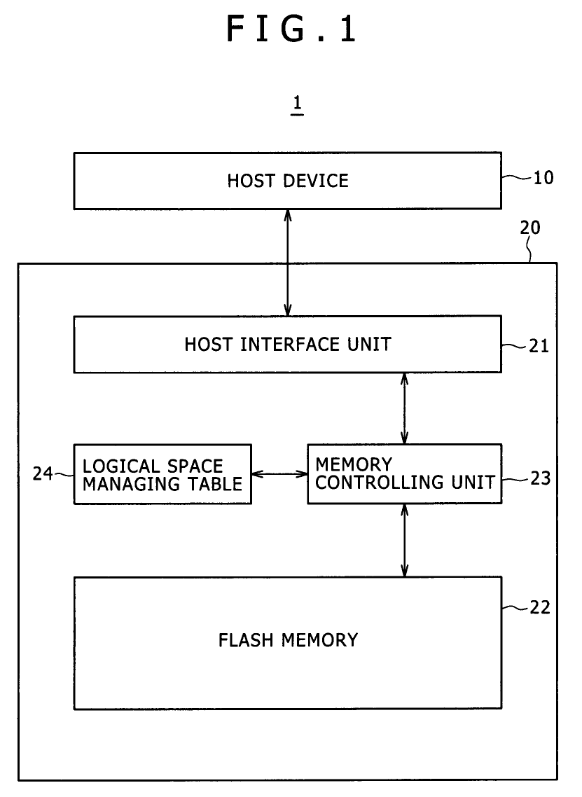

FIG. 1 is a diagram showing a configuration of a data communication system 1 according to an embodiment to which the present invention is applied. The data communication system 1 includes a host device 10 and a nonvolatile semiconductor storage device 20 detachably connectable to the host device 10.

The host device 10 can be for example a CE (Consumer Electronics) device such as a digital camera or the like, or a personal computer. The host device 10 has an internal configuration of an ordinary information processing device in which a CPU (Central Processing Unit), a ROM (Read Only Memory), and a RAM (Random Access Memory) are connected to an internal bus.

The host device 10 transmits and receives data and commands to and from the nonvolatile semiconductor storage device 20 using SCSI (Small Computer System Interface).

The nonvolatile semiconductor storage device 20 includes a host interface unit 21, a flash memory 22, and a memory controlling unit 23 for controlling the flash memory 22. In addition, the nonvolatile semiconductor storage device 20 includes a CPU, a ROM, a RAM and the like (not shown). The CPU reads a program stored in the ROM, expands the program into the RAM, and executes the program, thereby controlling data processing in general. In addition, the RAM manages a logical block list including information indicating current use states (a used state, an unused state or the like) of logical blocks, and has a logical space managing table 24 for associating logical block addresses and physical block addresses with each other, and managing the logical block addresses and the physical block addresses.

An application program for dividing a logical space or uniting logical spaces in the flash memory 22 is written to the ROM provided in the nonvolatile semiconductor storage device 20. This application program is expanded and executed in the RAM of the host device 10. Incidentally, this application may be installed onto the host device 10 by a user and then executed.

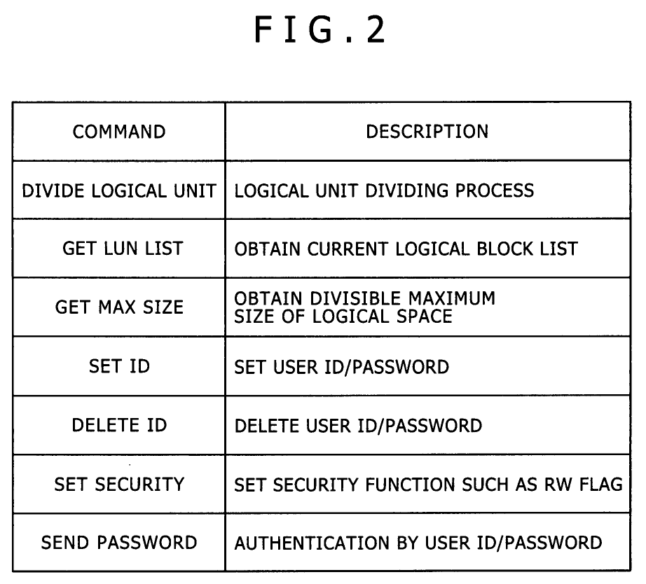

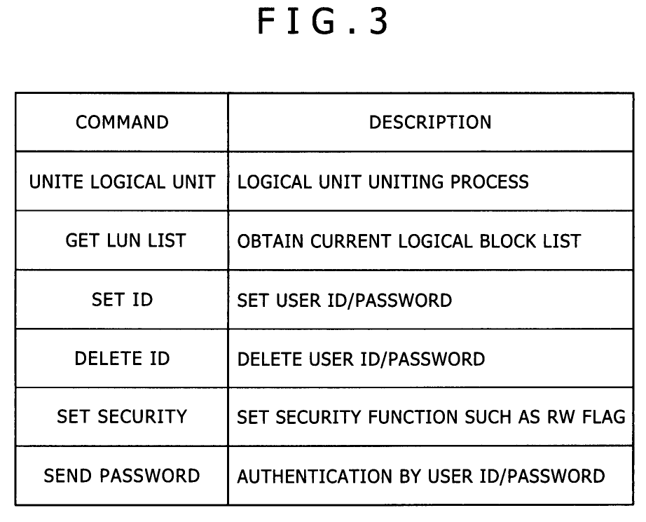

In order to perform a process of dividing a logical space or uniting logical spaces in the flash memory 22 provided in the nonvolatile semiconductor storage device 20 on the basis of a request by the user, the application issues a command for the dividing process, a command for the uniting process, and a command for setting a security function for a logical unit as shown in FIG. 2 and FIG. 3, for example. Incidentally, details of the process of dividing a logical space or the process of uniting logical spaces on the basis of these commands will be described later.

The host interface unit 21 transmits and receives data to and from the host device 10. In addition, the host interface unit 21 receives a command issued by the application being executed by the host device 10, and notifies the description of the command to the memory controlling unit 23.

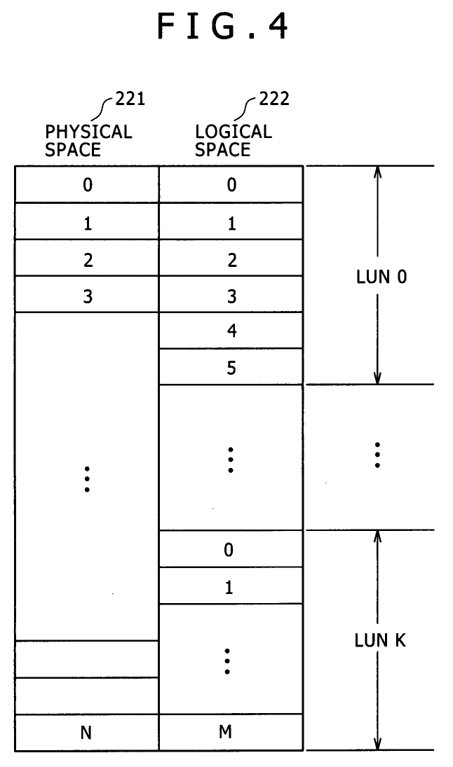

As shown in FIG. 4, the flash memory 22 has a physical space 221 composed of N+1 physical blocks and a logical space 222 composed of N+1 logical blocks.

The physical blocks forming the physical space 221 are a physical space in which data is stored. A physical block address n (n=0, 1, . . . , N) is given to each physical block.

The logical blocks forming the logical space 222 are a space in which data to be processed is written when the host device 10 performs a process of for example overwriting or reading the data. A logical block address (0, 1, . . . , M) as an index value in a virtual memory of the nonvolatile semiconductor storage device 20 is given to each logical block. In the logical space 222, a logical space composed of a predetermined number of logical blocks is set as one logical unit. Logical unit numbers (LUNs) such as LUN0, LUN1, and LUNK in order are given to respective logical units. For example, a logical space composed of a logical block 0, a logical block 1, . . . , and a logical block 5 shown in FIG. 4 is managed as LUN0.

The memory controlling unit 23 searches the logical space 222 for logical blocks in which data is not written, that is, unused logical blocks on the basis of a predetermined command issued by the application, divides a logical space composed of the unused logical blocks from the original logical space, and manages the plurality of logical spaces obtained by this dividing process as different logical units (LUN0, LUN1, . . . , and LUNK) within the logical space managing table 24.

The logical space managing table 24 manages, as a logical space list, information on the number of logical blocks in which data is written, that is, used logical blocks, the number of unused logical blocks, correspondences between logical block addresses (0, 1, . . . , and M) and LUNs (LUN0, LUN1, . . . , and LUNK), the number of logical units, logical unit numbers (LUN), a used space of the logical space, a free space of the logical space, and the like. In addition, the logical space managing table 24 associates the logical block addresses given to the logical blocks 222 as objects of data processing with the physical block addresses given to the physical blocks 221, and manages the logical block addresses and the physical block addresses.

The memory controlling unit 23 controls the managing operation of such a logical space managing table 24. For example, when the memory controlling unit 23 receives a command (Get LUN List) requesting obtainment of a logical block list within the flash memory 22 from the host device 10 via the host interface unit 21, the memory controlling unit 23 transmits information of the logical block list to the host device 10. When the memory controlling unit 23 receives a command requesting reading, writing, erasing or the like of data stored in the flash memory 22 from the host device 10 via the host interface unit 21, the memory controlling unit 23 refers to the logical space managing table 24, converts the logical block address of a logical block in which the data to be read, written, or erased, for example, is stored into a physical block address, and identifies a physical block that has the physical block address and in which the data is stored. The memory controlling unit 23 then performs the reading, writing, erasing or the like of the data.

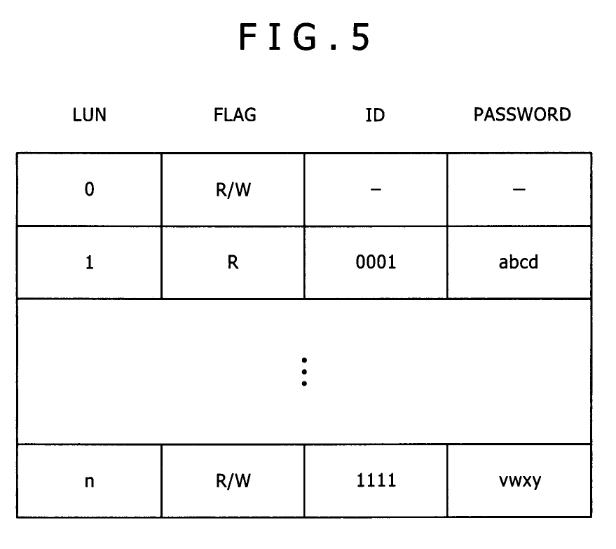

In addition, as shown in FIG. 5, for example, the memory controlling unit 23 can set security functions such as a flag, an ID, and a password to each logical unit indicated by LUN0, . . . , LUNn. In this case, a flag R indicates that only a reading process is allowed. A flag W indicates that only a writing process is allowed. A flag R/W indicates that reading and writing are both allowed. An ID and a password play a role of lock release, which is necessary when each logical unit is accessed.

For example, a user can access the logical unit LUN0 without inputting an ID or a password, and perform both a reading process and a writing process on the logical unit LUN0. The user can access the logical unit LUN1 by inputting an ID 0001 and a password abcd, and perform only a reading process on the logical unit LUN1. The user can access the logical unit LUNn by inputting an ID 1111 and a password vwxy, and perform both a reading process and a writing process on the logical unit LUNn.

Description will next be made of the process of dividing a logical space 222 and the process of uniting logical spaces 222 in the nonvolatile semiconductor storage device 20.

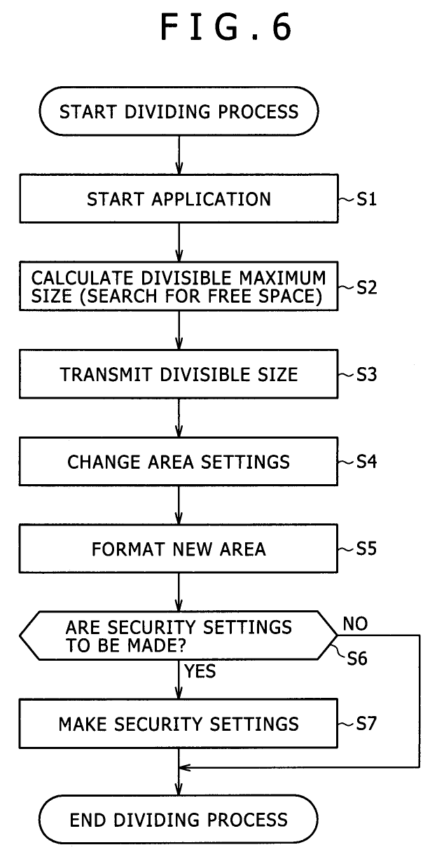

FIG. 6 is a flowchart of assistance in explaining an example of the process of dividing a logical space in the nonvolatile semiconductor storage device 20.

When the dividing process is initiated, in step S1, the host device 10 starts an application. As shown in FIG. 2; for example, the application issues a command for the dividing process, a command for setting security functions to a logical unit, and the like. When the application requests obtainment of a logical space list, the host device 10 transmits a command (Get LUN List) to the nonvolatile semiconductor storage device 20. Receiving the command (Get LUN List) via the host interface unit 21, the memory controlling unit 23 transmits, to the host device 10, information on the number of used logical blocks, the number of unused logical blocks, correspondences between logical block addresses (0, 1, and M) and LUNs (LUN0, LUN1, . . . , and LUNK), the number of logical units, logical unit numbers (LUN), a used space of the logical space, a free space of the logical space, and the like entered in the logical space list stored in the logical space managing table 24.

In step S2, when the application requests obtainment of a divisible maximum size of a logical space, the host device 10 transmits a command (Get Max Size) to the nonvolatile semiconductor storage device 20. Receiving the command (Get Max Size) via the host interface unit 21, the memory controlling unit 23 calculates the divisible maximum size of a logical space by searching the logical space 222 for unused logical blocks. The memory controlling unit 23 then transmits the divisible maximum size of the logical space 222 to the host device 10. In step S2, the memory controlling unit 23 searches even a logical unit having logical blocks in which data is written for a free space composed of unused logical blocks.

In step S3, when the user specifies a desired size referring to the divisible maximum size on the application, the host device 10 transmits the size specified by the user to the nonvolatile semiconductor storage device 20.

In step S4, the host device 10 transmits a command (Divide Logical Unit) for dividing a logical space of the size specified by the user on the application to the nonvolatile semiconductor storage device 20. Receiving the command (Divide Logical Unit) via the host interface unit 21, the memory controlling unit 23 obtains a free space of the size specified by the user from the logical space 222 possessed by the flash memory 22. Then, the memory controlling unit 23 divides the obtained logical space composed of unused logical blocks from the logical space 222. The memory controlling unit 23 manages the plurality of logical spaces obtained by this dividing process as new separate logical units, respectively.

In step S5, the memory controlling unit 23 formats each of the logical units obtained by the dividing process in step S4.

In step S6, the memory controlling unit 23 determines whether to set security functions to the newly set logical units (LUN0, LUN1, . . . ) according to contents input by the user. When it is determined in step S6 that security functions are to be set, the process proceeds to step S7, where the memory controlling unit 23 sets security functions such as a flag, an ID, and a password to the newly set logical units. When it is determined in step S6 that security functions are not to be set, on the other hand, the series of dividing processes is ended.

Incidentally, in the present embodiment, when the host device 10 transmits a command requesting a size specified by the user in advance to the nonvolatile semiconductor storage device 20, the memory controlling unit 23 compares the divisible maximum size of the logical space 222 with the size specified by the user in advance, and the divisible maximum size of the logical space 222 is equal to or larger than the size specified by the user, a logical space of the size specified by the user which logical space is composed of unused logical blocks is obtained by the above-described dividing process, and when the divisible maximum size of the logical space 222 is smaller than the size specified by the user, the above-described dividing process may be prevented from being performed.

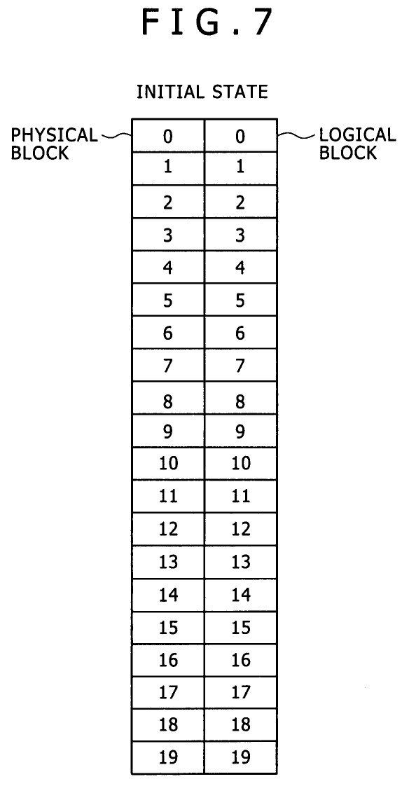

FIG. 7 is a diagram showing an example of an initial state of the memory having a physical space formed by unused physical blocks (a physical block 0, . . . , and a physical block 19) and a logical space formed by unused logical blocks (a logical block 0, . . . , and a logical block 19).

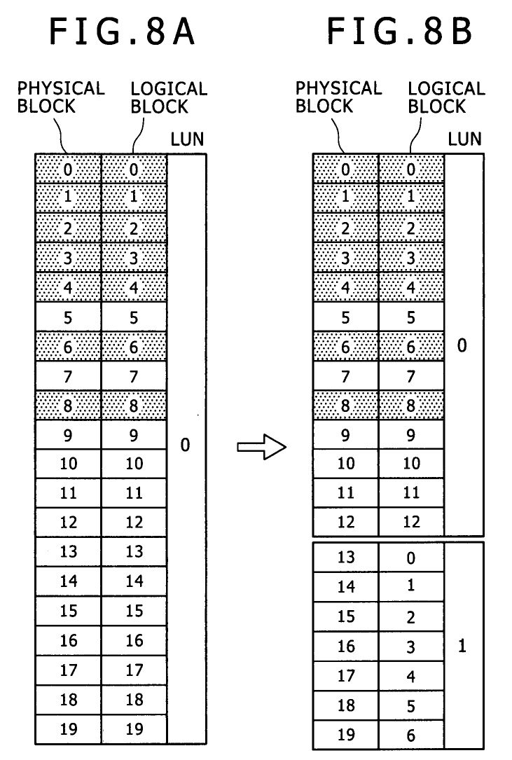

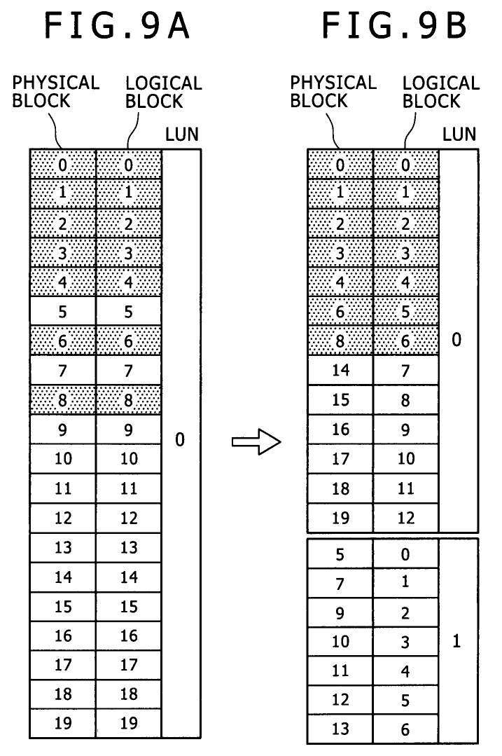

FIGS. 8A, 8B, 9A, and 9B are diagrams showing examples of dividing the logical space in a state in which some of the physical blocks and the logical blocks shown in FIG. 7 are used. For example, as shown in FIG. 8A, when a logical space composed of the logical block 13, . . . , and the logical block 19 corresponding to the physical block 13, . . . , and the physical block 19, respectively, is divided from the original logical space, as shown in FIG. 8B, the logical blocks corresponding to the physical block 13, . . . , and the physical block 19 obtained by the dividing process are given logical block numbers 0, . . . , and 6 in order, and a logical space formed of the newly obtained logical blocks 0, . . . , and 6 is given a logical unit number LUN1 and managed.

For example, as shown in FIG. 9A, when the logical block 5 corresponding to the physical block 5, the logical block 7 corresponding to the physical block 7, and the logical block 9, . . . , and the logical block 13 corresponding to the physical block 9, . . . , and the physical block 13, respectively, are grouped together and divided from the original logical space, as shown in FIG. 9B, the logical blocks corresponding to the physical block 5, . . . , and the physical block 13 obtained by the dividing process are given logical block numbers 0, . . . , and 6 in order, and a logical space formed of the newly obtained logical blocks 0, . . . , and 6 is given a logical unit number LUN1 and managed.

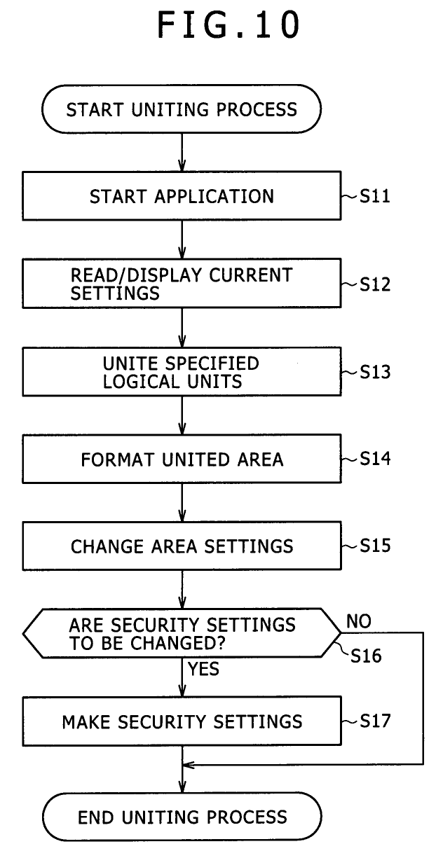

FIG. 10 is a flowchart of assistance in explaining an example of the process of uniting logical spaces in the nonvolatile semiconductor storage device 20.

When the uniting process is initiated, in step S11, the host device 10 starts an application. The application issues commands shown in FIG. 3, for example.

In step S12, after the host device 10 transmits a command (Get LUN List) to the nonvolatile semiconductor storage device 20, the memory controlling unit 23 transmits, to the host device 10, information on the number of logical units existing in the flash memory 22, logical unit numbers (LUN), a used space of the logical units, a free space of the logical units, and the like. The host device 10 presents these pieces of information obtained from the nonvolatile semiconductor storage device 20 to the user on the application.

In step S13, after the user specifies logical units to be united referring to the information presented on the application, the host device 10 transmits a command (Unite Logical Unit) requesting a process of uniting the logical units to be united to the nonvolatile semiconductor storage device 20. The memory controlling unit 23 performs the process of uniting the logical units to be united.

In step S14, the memory controlling unit 23 formats a logical space obtained by the uniting process. The memory controlling unit 23 manages each logical space as a logical unit (LUN0, LUN1, . . . ).

In step S15, information on the logical unit obtained by the uniting process is updated, and various function settings for the logical unit are changed.

In step S16, the memory controlling unit 23 determines whether to set security functions to the newly set logical unit (LUN0, LUN1, . . . ) according to contents input by the user. When it is determined in step S16 that security functions are to be set, the process proceeds to step S17, where the memory controlling unit 23 sets security functions such as a flag, an ID, and a password to the newly set logical unit. When it is determined in step S16 that security functions are not to be set, on the other hand, the series of uniting processes is ended.

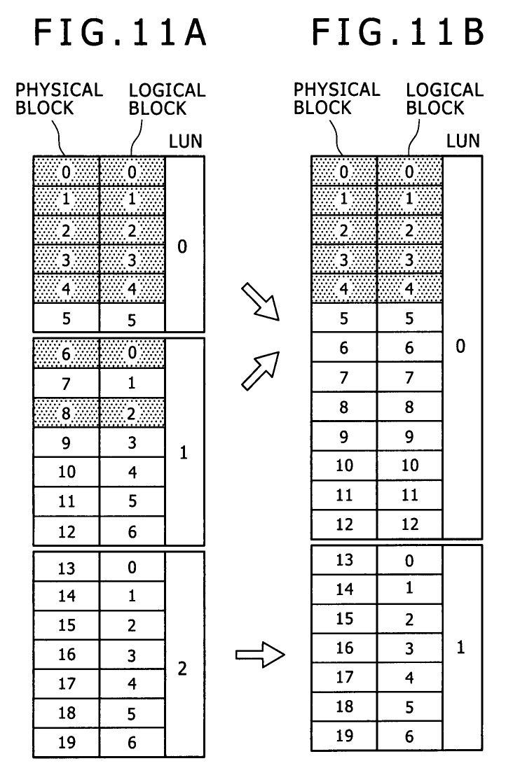

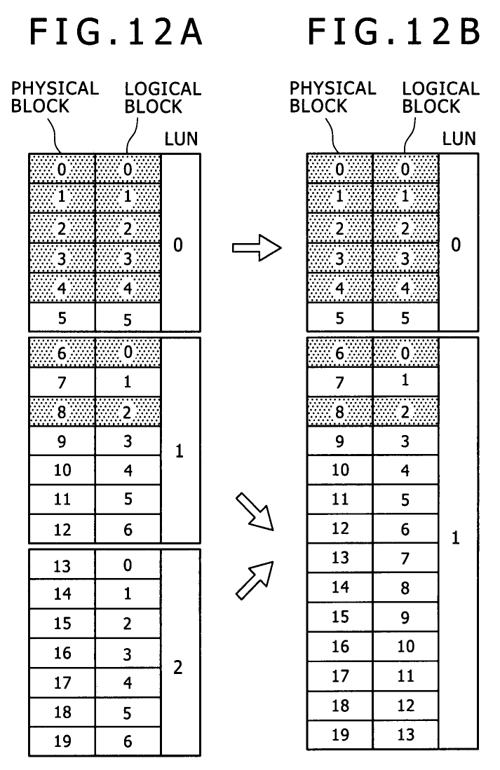

FIGS. 11A, 11B, 12A, and 12B are diagrams showing examples of uniting logical spaces in a state in which some of the physical blocks and the logical blocks shown in FIG. 7 are used. For example, when the logical space is divided into logical spaces LUN0, LUN1, and LUN2, according to a command indicating a request of the user, data stored in the physical block 6 and the physical block 8 in the logical space LUN1 as shown in FIG. 11A may be erased, and thereafter the logical spaces LUN0 and LUN1 may be united as shown in FIG. 11B so that a new logical space composed of the logical spaces LUN0 and LUN1 is obtained. In addition, according to a command indicating a request of the user, without erasing data stored in the physical block 6 and the physical block 8 in the logical space LUN1 as shown in FIG. 12A, the logical spaces LUN1 and LUN2 may be united as shown in FIG. 12B to obtain a logical space composed of new logical spaces LUN0 and LUN1.

Thus, in the data communication system 1 according to one embodiment to which the present invention is applied, the logical space within the flash memory 22 is logically divided by the control of the memory controlling unit 23 provided in the nonvolatile semiconductor storage device 20. Therefore the host device 10 does not perform a special process, and a risk of data being destroyed accidentally by the user can be avoided.

In addition, in the data communication system 1, the nonvolatile semiconductor storage device 20 can set security functions such as a flag, an ID, and a password to each logical space. Thus, a high level of security can be maintained even when one nonvolatile semiconductor storage device is used by a plurality of users.

Further, in the data communication system 1, the nonvolatile semiconductor storage device 20 divides or unites logical spaces within the flash memory 22 according to a request of the user. Therefore one memory area can be used differently for various purposes.

It is to be noted that the present invention is not limited to only the above-described embodiments, and that various changes can of course be made without departing from the spirit of the present invention.

It should be understood by those skilled in the art that various modifications, combinations, sub-combinations and alterations may occur depending on design requirements and other factors insofar as they are within the scope of the appended claims or the equivalents thereof.

What is claimed is:

1. A data storage device detachably connected to a host device, said data storage device comprising:
a memory having a logical space composed of at least one logical unit;
a logical space managing table for managing said logical space; and
controlling means for controlling a managing operation of said logical space managing table, and when said host device makes a request to divide said logical space, searching said logical space for unused logical blocks, dividing a logical space composed of said unused logical blocks from said logical space, and performing control to manage a plurality of the obtained logical spaces as different logical units, respectively.

2. The data storage device according to claim 1, wherein when said host device makes a request to unite said logical units, a plurality of said logical units obtained by a dividing process are united.

3. The data storage device according to claim 1, wherein even a logical unit in which data is written is searched for said unused logical block.

4. The data storage device according to claim 1, wherein when said controlling means receives a command requesting obtainment of a divisible maximum size of said logical space from said host device, said controlling means calculates the divisible maximum size of said logical space by searching said logical space for unused logical blocks, and presents the divisible maximum size of said logical space to said host device.

5. The data storage device according to claim 1, wherein when said host device makes a request to divide a logical space of a size specified by a user, said controlling means compares the size specified by said user with a divisible maximum size in said logical space, said controlling means divides a logical space composed of unused said logical blocks corresponding to the size specified by said user from said logical space in a case where the divisible maximum size in said logical space is equal to or larger than the size specified by said user, and said controlling means refrains from performing a dividing process in a case where the divisible maximum size in said logical space is smaller than the size specified by said user.

6. The data storage device according to claim 1, wherein said controlling means sets a flag allowing reading and/or writing to said logical units.

7. The data storage device according to claim 1, wherein said controlling means sets an ID and/or a password to said logical units.

8. A data controlling method for use by a data storage device, said data storage device including a memory having a logical space composed of at least one logical unit and being detachably connected to a host device, said data controlling method comprising:
controlling a managing operation of a logical space managing table for managing said logical space, and when said host device makes a request to divide said logical space, searching said logical space for unused logical blocks, dividing a logical space composed of said unused logical blocks from said logical space, and performing control to manage a plurality of the obtained logical spaces as different logical units, respectively.
